(19) United States
(12) Patent Application Publication
(10) Pub. No.: US 2006/0274916 A1
(43) Pub. Date: Dec. 7, 2006

(54) Remote data access

(75) Inventors: Chin F. Chan, Allston, MA (US); Richard J. Abraham, Lowell, MA (US); Junghyun Park, Westfield, MA (US); Bruce S. Lee, Winchester, MA (US); Keith M. McClelland, Needham, MA (US); Paul J. Hurd, Norfolk, MA (US)

Correspondence Address: WOLF GREENFIELD & SACKS, PC, FEDERAL RESERVE PLAZA, 600 ATLANTIC AVENUE, BOSTON, MA, 02210-2206, US

(73) Assignee: L-3 Communications Security and Detection Systems, Woburn, MA (US)

(21) Appl. No.: 11/448,178

(22) Filed: Jun. 6, 2006

Related U.S. Application Data
(63) Continuation-in-part of application No. 10/262,550, filed on Oct. 1, 2002, now abandoned.
Application No. 10/262,550 is a continuation-in-part of application No. 10/116,693, filed on Apr. 3, 2002.
Application No. 10/116,693 is a continuation-in-part of application No. 10/116,714, filed on Apr. 3, 2002, now Pat. No. 6,707,879.
Application No. 10/116,714 is a continuation-in-part of application No. 10/116,718, filed on Apr. 3, 2002, now Pat. No. 6,721,391.
(60) Provisional application No. 60/326,406, filed on Oct. 1, 2001.

(51) Int. Cl. G06K 9/00; G01N 23/04

(52) U.S. Cl. 382/100; 378/57

(57) ABSTRACT

The application discloses a system and methods for remote access and analysis of data collected about items under inspection. The system includes a data collection station, that may include an X-ray scanner, that scans the items under inspection to obtain data about the items. The data is transmitted to one or more remote expert stations, where a remote expert analyzes the data to determine whether the item contains a potential threat, such as, for example, explosives or other contraband.

### CROSS-REFERENCE TO RELATED APPLICATIONS

This application is a continuation (CON) of and claims priority under 35 U.S.C. §120 to U.S. application Ser. No. 10/262,550, entitled “remote Data Access” filed Oct. 1, 2002, which claims priority under 35 U.S.C. § 119(e) to U.S. Provisional Application Ser. No. 60/326,406 entitled “Remote Data Access,” filed on Oct. 1, 2001, and is a continuation-in-part (CIP) of, and claims priority under 35 U.S.C. § 120 to, commonly-owned U.S. patent application Ser. No. 10/116,693, entitled “A Remote Baggage Screening System, Software and Method,” filed Apr. 3, 2002, Ser. No. 10/116,714, entitled “A Remote Baggage Screening System, Software and Method,” filed Apr. 3, 2002, and Ser. No. 10/116,718, entitled “A Remote Baggage Screening System, Software and Method,” filed Apr. 3, 2002, each of the above applications of which are herein incorporated by reference in their entirety.

### BACKGROUND

1. Field of the Invention

The present invention relates to a system and method for remotely transmitting X-ray data over a communication channel to enable remote access to, and analysis of, that data. One application for the invention is in the field of baggage screening.

2. Discussion of Related Art

A number of conventional systems for screening baggage at airports are in use, including X-ray scanners, computed tomography (CT) scanners, and the like. Some of the systems are largely automated, and include computing equipment and that implements threat detection software. Some of these and other such systems are multilevel screening systems which may involve human operation in at least some levels of the screening process. An operator views a reconstructed image of an item under inspection on a monitor or view-screen, and makes decisions regarding, for example, whether the item may present a threat, and/or should be subjected to more detailed screening.

Presently existing systems provide differing degrees of sophistication in terms of their ability to analyze and screen objects based on X-ray data obtained about the object. Some, for example, balance the speed of baggage screening with the degree of certainty in screening for explosives, contraband and the like. In addition, especially in the United States, operators of such systems have varying levels of skill. Often, operators of first-level screening equipment for checked or carry-on baggage at airports have a lower level of skill than those who may be located remote from such equipment.

There exists a need for improved systems and methods for baggage screening for explosives, contraband and the like at airports and in other locations.

### SUMMARY OF THE INVENTION

In one aspect, the invention relates to a baggage processing system that has a plurality of CT scanners for scanning a bag, each of the CT scanners including a computer for processing data from the CT scanner and for reconstructing an image of least a portion of the bag; at least one operator review station for displaying a reconstructed image; and a network for transferring a reconstructed image from at least one CT scanner to the at least one operator station for display.

In one embodiment, the computer in each of the CT scanners includes means for detecting a potential threat in a bag based upon reconstructed image, and a reconstructed image is transferred to the at least one operator review station upon detection of a potential threat.

In another embodiment, at least one of the plurality of CT scanners is located at an airport security check-point. In another embodiment, the baggage processing system one of the plurality of CT scanners is located at a location other than an airport to which bags are to be transported.

In another aspect, the invention relates to a method for processing checked bags at an airport comprising the steps of, at a plurality of locations in the airport scanning bags and reconstructing at least one image of a portion of each bag; detecting a potential threat based upon reconstructed images; distributing bags to airplanes if a potential threat is not detected; and transferring the at least one image to a review location if a potential threat is detected. At the review location at least one image is displayed for review by an operator.

In one embodiment, the method further comprises, at the review location, receiving an indication from the operator of a threat or not a threat based upon the displayed image; and transmitting the indication to the location which provided the image. At the plurality of locations, the indication from the review location is received. A bag is distributed to an airplane based upon an indication of not a threat; and the bag is prevented from being distributed to an airplane upon indication of a threat.

According to one embodiment, a method for remotely analyzing an item under inspection comprises acts of collecting data about an item under inspection at a data collection location, transmitting the data to a remote location via a communication channel, analyzing the data at the remote location to determine a presence of a suspect object and provide a screening result, and transmitting the screening result to the data collection location. In one example, the method may further include establishing a telephone, or other voice and/or data, link between the data collection location and the remote location.

According to another embodiment, a remote screening system comprises a data collection station that scans an item under inspection to obtain data about the item under inspection, a remote expert station adapted to analyze the data about the item under inspection to provide a screening result for the item under inspection, and a communication channel that couples the data collection station to the remote expert station, wherein the data about the item under inspection is transmitted between the data collection station and the remote expert station via the communication channel.

### BRIEF DESCRIPTION OF THE DRAWINGS

The foregoing and other features, objectives and advantages of the present invention will be apparent from the following description with reference to the accompanying figures, which are provided for purposes of illustration only and are not intended as a definition of the limits of the invention. In the figures, in which like reference numerals indicate like elements throughout the different figures,

FIG. 1 is a schematic block diagram of an example of a multilevel screening system;

FIG. 2 is a schematic block diagram of one example of a remote data access system according to aspects of the invention;

FIG. 3 is a flow diagram illustrating aspects of one example of a method of remote data access, according to one embodiment of the invention;

FIG. 4 is a flow diagram illustrating aspects of an example of remote data access, according to an embodiment of the invention; and

FIG. 5 is a schematic block diagram of another example of a screening system, according to aspects of the invention.

### DETAILED DESCRIPTION

The present invention provides a system and methods for remote screening of objects that enables a remote expert, which may be a human operator, a machine or a combination thereof, to access and analyze data collected at another location and make screening decisions regarding the objects. It is to be understood that the invention is not limited in its application to the details of construction and the arrangement of components set forth in the following description or illustrated in the drawings. Other embodiments and manners of carrying out the invention are possible. Also, it is to be understood that the phraseology and terminology used herein is for the purpose of description and should not be regarded as limiting. The use of “including,” “comprising,” or “having” and variations thereof is meant to encompass the items listed thereafter and equivalents thereof as well as additional items. In addition, it is to be appreciated that the term “communication channel” as used herein refers to any now known or later developed channel for transmission of data, such as, but not limited to a telephone line, the Internet, a wireless channel, a local or wide area network link, an intranet, a dedicated link, and the like.

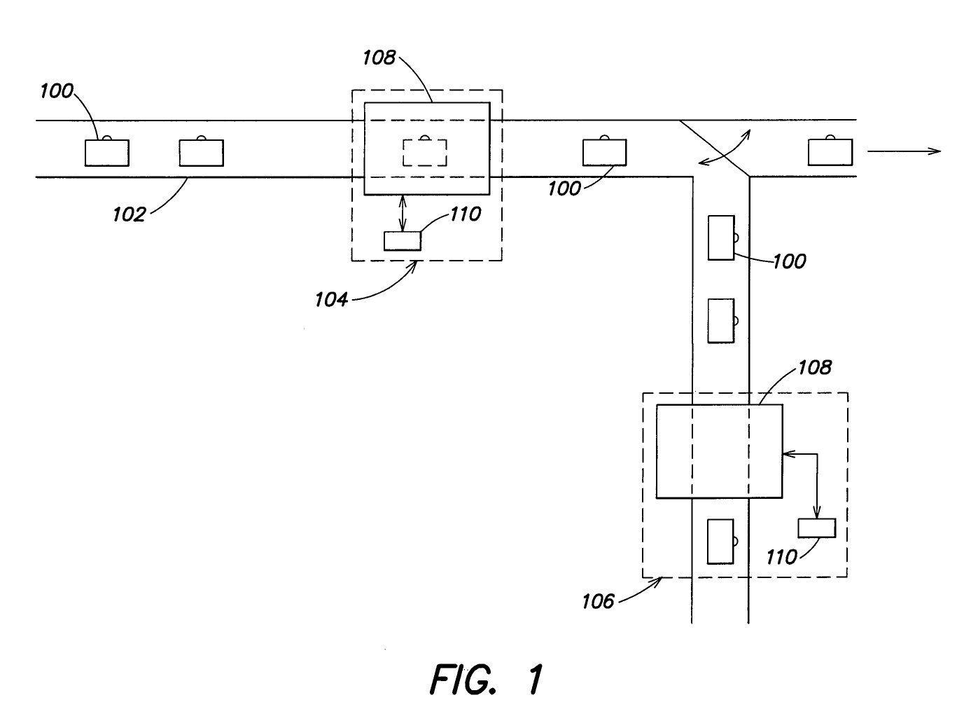

Referring to FIG. 1, there is illustrated one embodiment of a multilevel screening system, located for example, at an airport. It is to be appreciated that although the following discussion will refer primarily to baggage inspection systems located at airports, and to screening of baggage, the invention is not so limited, and may be equally applied to baggage screening at, for example, bus depots or train terminals, or to screening of packages at, for example, post offices or other mail centers. In the illustrated example, items of baggage 100 may be transported along a conveyor 102 and may be examined by one or more baggage inspection stations 104, 106. In this example, the system includes two levels of screening: a level one inspection station 104, and a level two inspection station 106. Items of baggage 100 that are not cleared by the level one station 104 may be transported to the level two inspection station 106 for further examination. It is to be appreciated that the system is not limited to two levels of screening, as shown, but may include only one level of screening or more than two levels of screening, as desired.

According to one embodiment, an inspection station, such as the level one or level two inspection stations 104, 106 illustrated in FIG. 1, may include an inspection machine 108 and an operator station 110, coupled to the inspection machine 108, that may be used to scan and screen an item under inspection. The item under inspection may be, for example, an item of baggage 100, or may be located within an item of baggage 100. The inspection machine may include, for example, a single-energy X-ray scanner, a dual-energy X-ray scanner, a CT scanner, a magnetic resonance imaging (MRI) scanner, a nuclear quadrapole resonance (NQR) scanner, any nuclear-based imaging scanner or gamma scanning system, or a combination of such scanners. It is to be understood that although the following discussion will refer, in particular, to X-ray data obtained about the item under inspection, any of the above-mentioned scanners may be used to scan the item and corresponding data may be obtained and analyzed according to the methods of the invention.

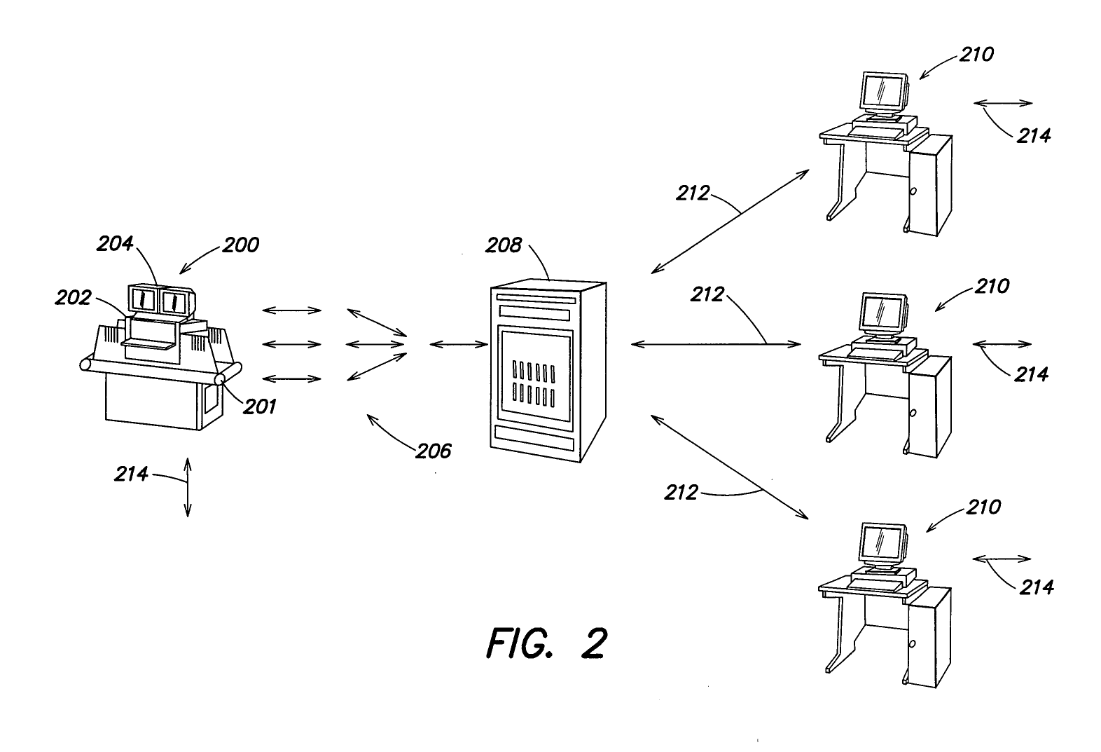

Referring to FIG. 2, a data collection station 200 may include an X-ray scanner 202, that may scan an item under inspection and obtain X-ray data about the item. The item may be placed on a conveyor belt 201 that may transport the item through the X-ray scanner. The data collection station may be, for example, either of the level one or level two inspection stations illustrated in FIG. 1. In one embodiment, the X-ray data may be passed to an operator interface 204, coupled to the X-ray scanner, which may display an X-ray image of the item under inspection, reconstructed from the X-ray data. An operator may examine the X-ray image and make a screening decision regarding the item under inspection. In some cases, the operator may decide that the item warrants further or more detailed inspection, and the item and X-ray data obtained about the item may be passed to, for example, a level two or level three inspection station. In conventional systems, the inspection stations, such as inspection stations 104, 106 (see FIG. 1) are connected in a closed, local area network. Data obtained by the level one inspection station 104 about an item of baggage 100 is sent only to the level two inspection station 106, and may be passed from the level two inspection station 106 to a level three inspection station if the system includes one. By contrast, according to some examples of the present invention, the X-ray data obtained about the item under inspection at the data collection station 200 may be transferred not only to a higher level inspection station, but to any number of remote locations, as is discussed in more detail below.

According to one embodiment, the X-ray data obtained about the item under inspection may be transferred across a communication channel 206 from the data collection station 200 to a remote server 208 which may in turn transfer the X-ray data to any one or more remote expert stations 210. As discussed above, the communication channel 206 may comprise any of a telephone line, the Internet, a wireless channel, a local or wide area network link, an intranet, a dedicated link, etc. that may be used to transfer data to a remote location. It is to be understood that the term “remote” as used herein refers to a location that is not on the same premises as the local item. For example, if a data collection station is located at a first terminal of an airport, a “remote” expert may be an expert located in a different city, at a location in the same city that is not the airport where the data collection station is located, or another terminal of the airport, etc. It is also to be appreciated that the system need not include a server 208 and that the data collection station 200 may transfer the X-ray data directly to a remote expert station 210, as is discussed in more detail below.

It is further to be understood that each of the data collection station 200 and remote expert stations 210 may include computing equipment and operator interfaces that may operate according to known principles. Thus, an operator at any station may “log on” to the system and access data and software using conventional computing operator interfaces known to those of skill in the art.

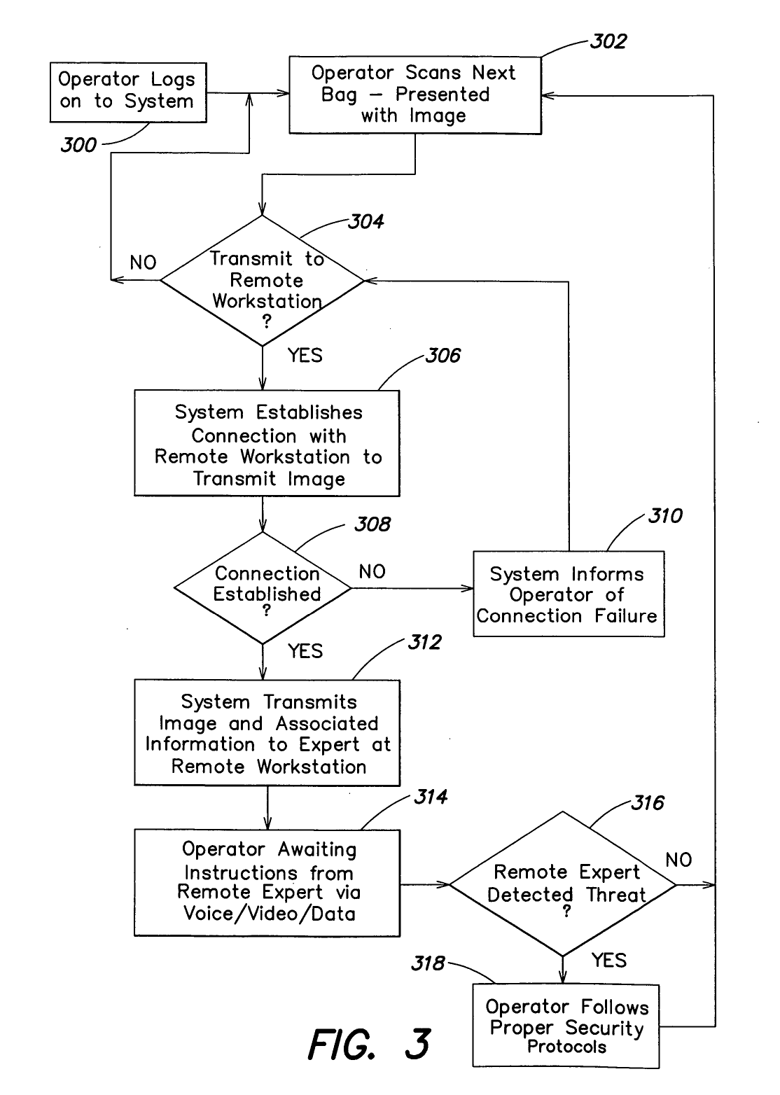

Referring to FIG. 3, there is illustrated a flow diagram of one example of a method of remote data access according to the present invention. In a first step 300, an operator may log on to a data collection station. This may occur at the beginning of an operator's shift, or when the data collection station begins operation on a particular day or at a particular time. It is to be appreciated that where the data collection station is automated and does not require the presence of a human operator, step 300 may represent the turning on of the X-ray scanner and/or associated computing system.

In a next step 302, the X-ray scanner at the data collection station may scan the item under inspection and collect X-ray data about the item under inspection. In one example, the X-ray scanner may scan the entire item, for example, an entire item of baggage. In another example, the X-ray scanner may scan a portion of the item, such as, for example, a previously identified suspect region within the item under inspection. The X-ray scanner may transfer the X-ray data to an operator interface where the operator may view an X-ray image of the item under inspection. In one embodiment, the operator interface may include computer equipment that may be adapted to run threat detection software. In this embodiment, the displayed X-ray image may include indications of potential threats that may have been detected by the software. For example, the image may include a threat polygon, or a highlighted region that may correspond to a potential threat located within the item under inspection.

If the operator determines that the item under inspection may potentially contain a threat, such as, for example, an explosive material or other contraband item, or that the item under inspection warrants more detailed analysis, the operator may decide to transmit the X-ray data to a remote expert station, as indicated by step 304. If, on the other hand, the operator decides that the item under inspection does not need to be examined by an expert, the item may be passed along to either a higher level inspection station or to a loading area, and the operator may allow a next item to be scanned by the X-ray scanner. It is to be appreciated that although this, and the following, discussion refers to a human operator viewing the X-ray image and making a decision regarding whether or not to transmit the X-ray data to the remote expert station, the invention is not so limited. The data collection station may not be operated by a human operator, and instead may include a computer processor and threat detection software that may automatically analyze the X-ray data obtained by the X-ray scanner and automatically decide whether or not to transfer the X-ray data to the remote expert station based upon, for example, particular threat detection algorithms.

When the operator (or software algorithm) determines that the item under inspection should be examined by a remote expert, the operator may transmit the X-ray data to the remote expert station via a communication channel, as illustrated in FIG. 2, and indicated by steps 306-312. In a first step 306, the operator may establish a link between the data collection station 200 and the remote expert station 210. In one example, this step may involve initiating a dial-up connection, for example, where the communication channel may be a telephone line or Internet connection. In another example, where the communication channel may include a dedicated link, this step may involve selecting a “send” option presented in the user interface software. If for some reason a connection between the data collection station and the remote expert station (or server) can not be established, the user interface software may inform the operator of connection failure (step 310) by, for example, displaying a connection error message or symbol, and the operator may take appropriate action. If the connection is successfully established (step 308), the X-ray data may be transferred to the remote expert station, as indicated in step 312.

It is to be appreciated that the X-ray data may be transmitted in step 312 using any conventional data transfer software and/or protocol. The X-ray data may be transmitted in digital or analog form, in mixed signal form, as compressed data (which may have been compressed using any compression algorithm or technique known to those skilled in the art), or in another form. The X-ray data transmitted may be raw X-ray data, or may be processed data, having been processed by software running on the data collection station operator interface. In addition, the transmitted data may include identification data in addition to the X-ray data so as to link or identify the X-ray data with a particular item under inspection. For example, the identification data may include data such as, but not limited to, data associated with a digital photograph of a passenger or person to whom the item under inspection belongs, flight information (such as flight number, airline, point of origin or destination), a passport number, a bar code of a ticket of the passenger, or other data regarding the item or the person to whom the item belongs. This identification data may be used by the remote expert during analysis of the X-ray data, as is discussed in more detail below. In some applications, it may be important to transmit the data over a secure communication channel, in which case, the data may be encrypted using an encryption algorithm as known to those skilled in the art, and/or may be transmitted using a secure transfer protocol, such as, for example, secure socket layer (SSL) protocol or secure hypertext transfer protocol (HTTPS) or another secure transfer protocol known to those of skill in the art. In another embodiment, the operator at the data collection station may email the X-ray and identification data to the remote expert station.

In contrast to systems in which a remote operator may request data from a data collection station (i.e., “pull” data), the system and methods disclosed herein allow for an operator at the data collection station to “push” the data to a remote expert station, i.e., the operator initiates transfer of the data when deemed necessary or desirable. As illustrated in FIG. 2, the system may include a plurality of remote expert stations, each of which may be co-located or disposed at different locations. In one embodiment, the operator at the data collection station 200 may select to which remote expert station to transmit the X-ray data based on, for example, the type of threat suspected to be present within the item under inspection. For example, one remote expert may be particularly qualified to analyze X-ray data from an item under inspection that potentially contains an explosive, whereas another remote expert may be particularly qualified to examine data from an item that may contain agricultural contraband. If either the operator or computing equipment present at the data collection station is capable of making an initial determination about the type of threat potentially present in a suspect item, then the remote expert may be selected on this basis. In another embodiment, the system may include a server 208, as illustrated. All X-ray data may be transmitted from the data collection station 200 to the server 208, which may pass the X-ray data on to a selected remote expert station 210 based on criteria such as, for example, availability of the remote experts, the amount of data traffic present on any given link 212 to a particular remote expert station, etc. Once the data has been transmitted to the remote expert station, the operator may wait for instructions from the remote expert regarding handling of the item under inspection, as illustrated by step 314. During this waiting period, the suspect item under inspection may be removed from the conveyor and stored so that other items may be scanned in the meantime.

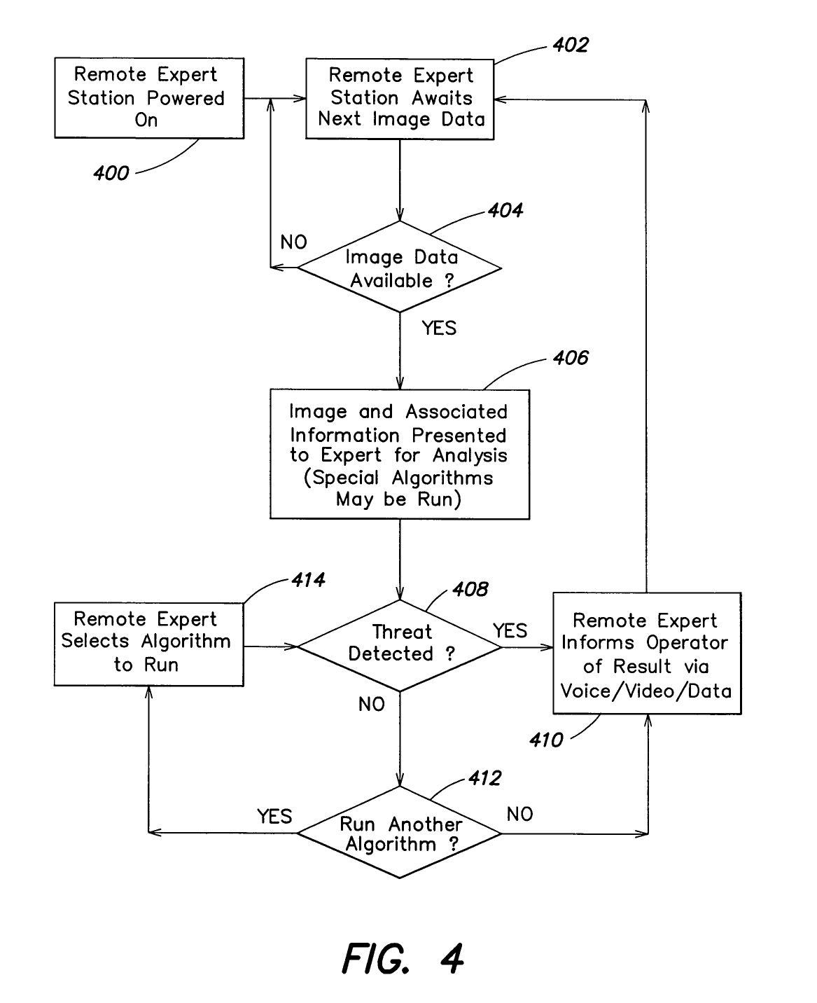

Referring to FIG. 4, there is illustrated a flow diagram of one example of a method of remote data analysis occurring at the remote expert station. In a first step 400, an operator may log on to a remote expert station, and/or computing equipment located at the remote expert station may be powered on. This step may represent the beginning of an operator's shift at the remote expert station, or the beginning of the day, etc. In next steps 402 and 404, the remote expert station waits for an operator at the data collection station to initiate a data transfer and send the X-ray data and associated identification data. It is to be appreciated that once the operator at the data collection station initiates transfer of the data to the remote expert station, the remote expert may access the transmitted data through any protocol known to those of skill in art, such as, but not limited to, email, an Internet web page, an intranet, and the like. In some examples, the remote expert may be required to enter a password to access any new data, or to access encrypted data. In another example, a password may only be required at the log on step 400.

In one embodiment where the system includes a server, the server may store X-ray and identification data collected about items under inspection at the data collection station. When a remote expert station becomes operational (step 400), the remote expert may access the server and retrieve stored data for analysis.

It is to be appreciated that the term “remote expert” as used herein may refer to a trained human operator, who may have a higher level of skill or more expertise than an operator at the data collection station. The term may also refer to a computing system that may include sophisticated threat detection software adapted to analyze the X-ray data and produce, for example, a clearing decision (i.e., threat or no threat detected) or a threat polygon, etc., that may then be transmitted back to the operator at the data collection station. Thus, in some embodiments, the remote expert may be a human operator that may work in conjunction with threat detection software running on the computing equipment at the remote expert station, and in other embodiments a human operator may not be present at the remote expert station.

In step 406, the remote expert may analyze received X-ray data for potential threat items, such as, for example, explosives or other contraband. As discussed above, the transmitted data may include raw X-ray data, in which case computing equipment at the remote expert station may perform data processing to provide an X-ray image of the item under inspection for analysis by the remote expert. The computing equipment may further include advanced image and/or data processing software with which the remote expert may manipulate the X-ray data and/or image in order to determine whether or not a threat is present in the item under inspection. According to one embodiment, the remote expert may run tailored threat detection algorithms on the X-ray data, depending on information contained in the identification data. For example, the threat detection algorithm may be chosen based on a point of origin of the passenger associated with the item under inspection. Alternatively, the remote expert may run a variety of threat detection algorithms on the X-ray data, as shown by steps 408, 412 and 414, using multiple algorithms to attempt to locate or identify a suspicious region or material in the item under inspection (represented by the X-ray data).

As shown by steps 408-414, once the remote expert has completed analysis of the X-ray data, the remote expert may inform the operator at the data collection station of the result. The data (X-ray and identification) may be re-transmitted back to the data collection station, along with the remote expert's screening results. According to one embodiment, the remote expert may initiate a voice and/or video link with the operator at the data collection station. This may be done with any standard protocol known to those of skill in the art, using, for example, a conventional telephone link (wireless or land-line), or voice or video conferencing through the computing equipment. In one embodiment, the remote expert may engage in dialog with the operator at the data collection station, and may, for example, request that the item under inspection be re-scanned, or scanned from a different angle, etc., to assist the remote expert in analyzing the item. The remote expert may further provide the operator at the data collection station with instructions regarding handling of the item under inspection. For example, the remote expert may indicate that the item does not contain a threat and may be passed along to its destination. Alternatively, the remote expert may suggest that the operator contact other security officials, such as the police. In another embodiment, where the system and methods described herein may be applied to performing remote diagnostics on equipment or components, the remote expert may discuss with and instruct the operator at the data collection station regarding how to repair faulty equipment or components. It is to be understood that a voice connection between the remote expert and the operator may be established through the system (e.g., using the computing equipment at the stations) or using conventional land or wireless telephone lines that may not be otherwise associated with the screening system.

Referring again to FIG. 3, if the remote expert informs the operator at the data collection station that a threat was detected (step 316), the operator may respond appropriately (step 318) as discussed above. If no threat was detected, the operator may allow the item to continue on to either another inspection station or a loading point, and may continue to scan and screen other items. It is to be appreciated that, in one embodiment, remote analysis of the X-ray data collected about an item under inspection may occur in “real time,” i.e., as quickly as possible while the operator awaits instructions regarding the item. The remote screening may thus occur prior to a passenger being allowed to board a flight with the item under inspection. This is most likely the case where the screening is for the purpose of detecting explosives or other dangerous articles. Alternatively, remote screening, for example, for agricultural contraband or drugs, may be implements according to the methods described while the flight is in progress, and screening results may be transmitted to a destination point of the flight.

As discussed above, the data collection station 200 may be any of a level one, level two or level three inspection station in a multilevel screening system. In one example, the data collection station may be a level one inspection station, and the remote expert station may be considered to be a level two inspection station. In this example, an operator at the data collection station may transmit to the remote expert station X-ray data corresponding to only suspect items. In another example, where the data collection station may already be a level two or level three inspection station, X-ray data corresponding to all items under inspection may be transmitted to the remote expert for analysis, even if an operator at the data collection station does not detect a potential threat in an item under inspection. It is to be appreciated that the collected X-ray data may or may not be analyzed at the data collection station prior to transmission of the data to the remote expert station.

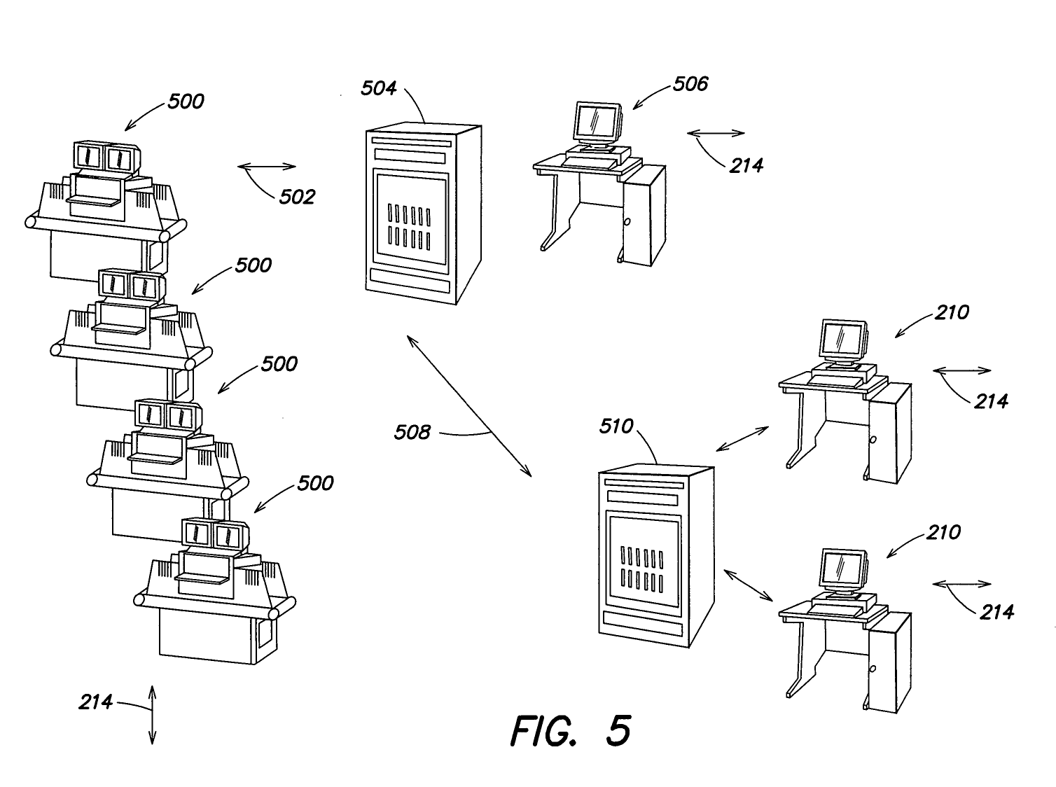

Referring to FIG. 5, there is illustrated another embodiment of a screening system implementing remote data access, according to aspects of the invention. In this embodiment, multiple data collection stations 500, each with X-ray scanning capabilities, may be located at different data collection locations. Each data collection station 500 may X-ray scan an object (item under inspection) and may have automated, first-level screening capabilities. Similarly, each may have a human operator who performs second level screening through viewing and/or manipulating a reconstructed image of scanned items on an operator interface. X-ray data of suspect items, possibly in combination with identification data relating to associated passengers, may be transmitted over a local network 502 to a local server 504 and local workstation 506, where Level 3 screening may be performed. Again, the screening may include automated detection software and/or a human expert who views and manipulates a reconstructed image of the object on the workstation operator interface, as discussed above.

Still further, a fourth level of even more expert screening, located remotely from the data collection stations 500 and local server 504, may be performed by transmitting X-ray data, and/or possibly additional passenger information, over a communications channel 508 to a remote server 510, as discussed above in reference to FIG. 2. Remote expert stations 210 may gain access to the transmitted information, via the remote server 510, and remote experts may analyze the X-ray data, as discussed in reference to FIG. 2.

In the system of FIG. 5, each level of screening may eliminate certain inspected items as “cleared,” i.e., containing no potential threats, and send only suspect items on for further screening, such that fewer and fewer items are analyzed by each higher level of screening. Any number of levels of screening, whether remote or local, can be supported by such a system, according to the present invention. The number of levels, and arrangement and locations of local and remote screening stations, may be arranged to suit a particular application or organization of an airport or airline, or the like.

In one embodiment, the occurrence of suspect items transmitted to a next higher level may be tracked via an electronic or automated system that may alert an expert at a next higher level when a certain frequency of suspect items have been noted in a single airport, in geographically related airports, on particular flight patterns, or in any type of pattern that may pose some kind of possible threat.

In another embodiment, experts at different locations may be able to collaborate. For example, two human experts, located at different locations, may be able to view the same reconstructed image of a scanned object where one of the operators, e.g., the remote operator, is manipulating the image. Additional collaborative tools may include text, voice, video, white board drawings, etc. that may be able to be shared through the communications channel, or over separate voice and/or video links as described above, between remotely located operators.

The present invention thus allows for remote, specialized analysis of data collected about an item under inspection, even if sophisticated data analysis, threat detection or image processing algorithms are not available at the data collection site. Furthermore, using a server (see FIGS. 2 and 5), remote experts may be networked, and X-ray data may sent to any currently available expert, regardless of their location. In addition, the system may also be used to transit “training data,” i.e., data that may have been artificially generated or stored from previous screenings, that may be used to train operators, experts and algorithms in detecting threat articles.

One of the advantages that results from the above described system is a method for remotely analyzing an item under inspection comprises acts of collecting data about an item under inspection at a data collection location, transmitting the data to a remote location via a communication channel, analyzing the data at the remote location to determine a presence of a suspect object and provide a screening result, and transmitting the screening result to the data collection location. In one example, the method may further include establishing a telephone, or other voice and/or data, link between the data collection location and the remote location.

In another aspect, a remote screening system comprises a data collection station that scans an item under inspection to obtain data about the item under inspection, a remote expert station adapted to analyze the data about the item under inspection to provide a screening result for the item under inspection, and a communication channel that couples the data collection station to the remote expert station, wherein the data about the item under inspection is transmitted between the data collection station and the remote expert station via the communication channel.

Having thus described various illustrative embodiments and aspects thereof, modifications, and alterations may be apparent to those of skill in the art. For example, the system and methods of the invention may be applied to remotely diagnosing faulty equipment, components or the like as well as to baggage screening. In addition, a data collection station may include a scanner other than an X-ray scanner, such as, for example, a CT scanner, and may transfer data other than X-ray data to the remote expert station, for example, CT data. Such modifications and alterations are intended to be included in this disclosure, which is for the purpose of illustration and not intended to be limiting. The scope of the invention should be determined from proper construction of the appended claims, and their equivalents.

What is claimed is:

1. A baggage processing system comprising:
a plurality of CT scanners for scanning a bag, each of the CT scanners including a computer for processing data from the CT scanner and for reconstructing an image of least a portion of the bag;
at least one operator review station for displaying a reconstructed image; and
a network for transferring a reconstructed image from at least one CT scanner to the at least one operator review station for display.

2. The baggage processing system of claim 1,
wherein the computer in each of the CT scanners includes means for detecting a potential threat in a bag based upon reconstructed image, and
wherein a reconstructed image is transferred to the at least one operator review station upon detection of a potential threat.

3. The baggage processing system of claim 2, wherein at least one of the plurality of CT scanners is located at an airline check-in desk.

4. The baggage processing system of claim 2, wherein at least one of the plurality of CT scanners is located at an airport security check-point.

5. The baggage processing system of claim 2, wherein at least one of the plurality of CT scanners is located at an airport curb-side check-in area.

6. The baggage processing system of claim 2, wherein at least one of the plurality of CT scanners is located at a location other than an airport to which bags are to be transported.

7. A method for processing checked bags at an airport comprising the steps of:
at a plurality of locations in the airport performing the step of:
scanning bags and reconstructing at least one image of a portion of each bag;
detecting a potential threat based upon reconstructed images;
distributing bags to airplanes if a potential threat is not detected; and
transferring the at least one image to a review location if a potential threat is detected; and
at the review location, performing the steps of:
displaying the transferred at least one image for review by an operator.

8. The method for processing checked bags of claim 7, further comprising the steps of:
at the review location performing the steps of:
receiving an indication from the operator of a threat or not a threat based upon the displayed image; and
transmitting the indication to the location which provided the image; and
at the plurality of locations performing the steps of:
receiving the indication from the review location;
distributing a bag to an airplane based upon an indication of not a threat; and
preventing distribution of the bag to an airplane upon indication of a threat.
